(19) United States
(12) Patent Application Publication
(10) Pub. No.: US 2003/0224733 A1
(43) Pub. Date: Dec. 4, 2003

(54) Method and apparatus for estimating signal quality for uplink interference avoidance

(76) Inventors: Uwe Schwarz, Veikkola (FI); Peter Muszynski, Espoo (FI); Harri Holma, Irving, TX (US); Sari Korpela, Espoo (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/421,891

(22) Filed: Apr. 24, 2003

Related U.S. Application Data
(60) Provisional application No. 60/375,832, filed on Apr. 29, 2002.

(51) Int. Cl. H04B 7/15

(52) U.S. Cl. 455/67.11; 455/11.1

(57) ABSTRACT

A communications method and apparatus are provided for estimating signal quality (Ec/IO) for uplink interference avoidance. This may involve measuring a signal strength of a carrier and estimating a value of RSCP. A signal quality estimate may be determined based on the measured signal strength and the estimated value of RSCP. Further operations (such as handovers) may be performed based on the estimated signal quality.

This application claims priority from U.S. Provisional Patent Application No. 60/375,832 filed Apr. 29, 2002, the subject matter of which is incorporated herein by reference.

### BACKGROUND

1. Field of the Invention

This invention relates to wireless telecommunication systems. More specifically, the present invention relates to estimating signal quality (EC/IO) of another carrier based on a measured signal strength.

2. Description of the Related Art

In current and future telecommunication systems, it is possible to perform handovers between different systems and different operators. For example, when a mobile terminal approaches the border of a service area, an inter-frequency handover may be triggered. FIG. 1 illustrates an inter-frequency handover necessitated by interference from a nearby radio system when the mobile terminal is located near the edge of its current cell. The interference may be represented by arrow 110. As shown, when the interference from a channel f4 of an Operator 2 affects the operation of the mobile terminal operated in a channel f3 of Operator 1, the adjacent channel interference may be escaped by inter-frequency handover 108 to another channel f2. The adjacent channel interference may also be escaped by inter-system handover to channel f4 of Operator 2.

Wideband Code Division Multiple Access (WCDMA) systems perform soft handovers in order to avoid or minimize uplink interference with neighboring cells in WCDMA. That is, uplink interference may be avoided with a soft handover within one frequency based on downlink CPICH Ec/IO measurement, or a so-called “downlink dying first” with adjacent channel interference. These methods of reducing or avoiding uplink interference may work when there is a fixed pair of uplink and downlink channels as in Universal Mobile Telecommunication System (UMTS) core band (e.g. 2.1 GHz). However, these techniques may not work for 2.5 GHz when the same uplink carrier in 1.9 GHz is paired with a downlink carrier in 2.1 GHz or in 2.5 GHz. New downlink inter-frequency measurements may be needed in order to avoid the uplink interference. However frequent inter-frequency measurements may cause problems for the system capacity and coverage if the measurements are not properly designed.

### SUMMARY OF THE INVENTION

Embodiments of the present invention may include a communications method that includes measuring a signal strength of a carrier and determining a signal quality estimate based on the measured signal strength. The signal strength may be a received signal strength indicator (RSSI) of a downlink signal for a co-sited carrier. The signal quality estimate may be an estimate of CPICH Ec/IO.

Embodiments of the present invention may also include estimating a value of RSCP. The estimated value of the RSCP is based on a difference of frequencies and a difference of pilot channel (CPICH) transmission powers.

In these embodiments, the signal quality estimate may be based on the measured signal strength and the estimated value of RSCP.

Embodiments of the present invention may avoid uplink interference based on the determined signal quality estimate. This may be accomplished by performing a handover based on the determined signal quality estimate.

Embodiments of the present invention may also include a communication system that includes at least one network device in a communications network and a mobile device operatively connected to the communications network. The mobile device may measure the signal strength of a carrier and the communications system may include a capability to determine a signal quality estimate based on the measured signal strength.

Other embodiments and features of the present invention will become apparent from the following detailed description taken in conjunction with the annexed drawings, which disclose preferred embodiments of the present invention.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto.

The following represents brief descriptions of the drawings in which like reference numerals represent like elements and wherein:

FIG. 1 is a diagram illustrating when handover is desired according to one example arrangement;

FIG. 2 is a diagram of a system according to an example embodiment of the present invention;

FIG. 3 is a diagram of an example interface scenario in an uplink channel according to an example arrangement;

FIG. 4 is a diagram of another example interface scenario in an uplink channel according to an example arrangement;

FIG. 5 is a graph showing RSSI versus geographical location; and

FIG. 6 is a flowchart of an example embodiment of the present invention.

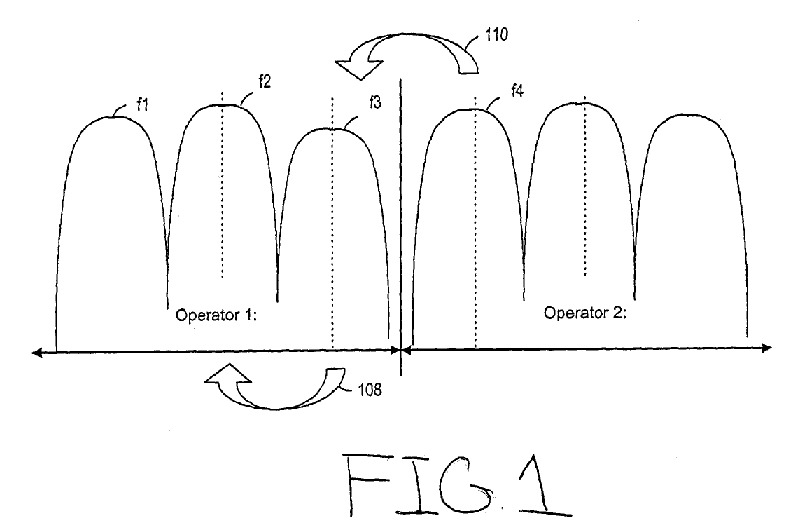

### DETAILED DESCRIPTION

The particulars shown herein are by way of example and for purposes of illustrative discussion of arrangements and embodiments of the present invention. The description taken with the drawings make it apparent to those skilled in the art how embodiments of the present invention may be embodied in practice.

Further, arrangements and embodiments may be shown in block diagram form in order to avoid obscuring the invention, and also in view of the fact that specifics with respect to implementation of such block diagram arrangements may be highly dependent upon the platform within which the present invention is to be implemented. That is, these specifics should be well within the purview of one skilled in the art. Where specific details (e.g., flowcharts) are set forth in order to describe example embodiments of the invention, it should be apparent to one skilled in the art that the invention can be practiced without these specific details.

Embodiments of the present invention relate to a communications method that includes measuring a signal strength (such as RSSI) of a carrier and determining a signal quality estimate (such as Ec/IO) based on the measured signal strength. Based on the determined signal quality estimate, a determination may be made regarding a handover in order to avoid uplink channel interference. Embodiments of the present invention relating to estimating Ec/IO are faster than arrangements that perform Ec/IO measurement. As such, a faster determination may be made with less network resources used.

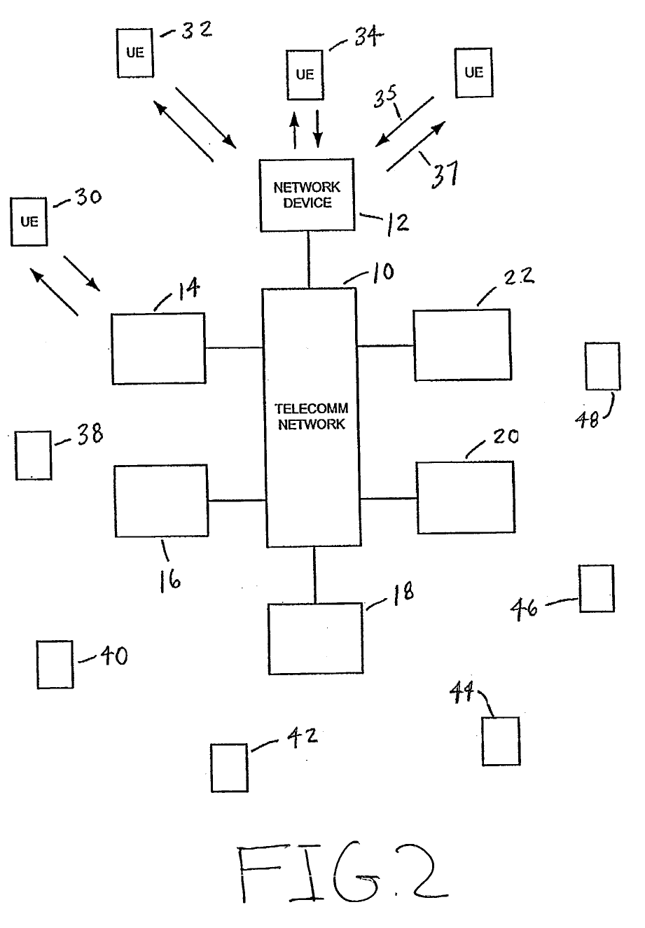

FIG. 2 shows a diagram of an example system according to an example embodiment of the present invention. Other embodiments and configurations are also within the scope of the present invention. The system includes a telecommunications network 10 that includes network devices or nodes 12-22 and mobile devices (e.g., user equipment (UE), mobile nodes (MN), mobile stations (MS), etc.) 30-48. The terms mobile device, mobile node, and user equipment may be used interchangeably throughout this disclosure to refer to the same type of device.

The network devices 12-22 may be any type of network node or device that supports wireless devices connected to a telecommunications network, for example, a Radio Network Controller (RNC), a Base Station Controller (BSC), etc. The network device 12 and the mobile device 36 transfer data and control information between each other via uplink channels 35 and downlink channels 37. A base station or cell (not shown) may supply frequencies from a particular band of frequencies that allow a mobile device 36 to select from and use for a downlink carrier and uplink carrier. The uplink carrier frequency and downlink carrier frequency may be from the same band of frequencies, or from different bands of frequencies.

As a mobile device moves from one location to another, the base station or cell closest to the mobile device will likely then supply the uplink and downlink carriers for the particular mobile device. Generally, if the same band of frequencies is available at the neighboring base station, the network device may direct a soft handover to occur between the downlink and uplink carriers supplied from the original base station to downlink and uplink carriers supplied from the neighboring base station.

A currently used network device 12 and/or neighboring network device 14, possibly along with the mobile device 36, may detect soft handover areas before a handover is to occur such that a handover may occur without causing uplink channel interference. Uplink interference may be caused when a mobile device moves to a location that does not supply the same bands of frequencies currently being used by the mobile device for its downlink carrier.

Each of the mobile devices 30-48 and/or the network devices 12-22 may perform various measurements in a periodic or continuous basis to detect soft handover areas for uplink interference avoidance. For example, measurements such as signal strength, signal quality, etc. may be made and compared with similar measurements of carriers from neighboring or co-sited bands to determine if a soft handover area exists and whether a handover should occur to avoid uplink interference. A network device and/or mobile device may determine the types of measurements made and when they are made. Moreover, a network device and/or mobile device may perform the measurements, where in the latter case, a network node may instruct the mobile device to perform the measurements or the mobile device perform the measurements without instruction from the network device. Further, the mobile device may perform the measurements and report the results to the network device whereby the network device decides whether a soft handover area exists and whether a soft handover should occur to avoid uplink interference.

Signal quality of a carrier (downlink or uplink) may include interference from other cells and may be related to the signal quality at a specific mobile device. In contrast, signal strength may include the sum of all the signals and indicate the total strength in a specific frequency. With signal strength measurements, there is no differentiating between a particular mobile device's signal and other signals. Co-sited downlink carriers are downlink carriers from the same antenna or same base station or cell as the downlink carrier currently being used by a mobile device.

Measurement of the relative signal quality may also be performed. In this method, signal quality may be measured and compared with the signal quality of downlink carriers from another base station. Differences between the two may be then used to determine if a soft handover area exists. Moreover, a mobile device currently using a current downlink carrier from a current cell and moving closer to a neighboring cell may look for a downlink carrier from the neighboring cell from the same frequency band as the current downlink carrier. If a downlink carrier is missing in this band, then the network device and mobile device know that a soft handover area exists where uplink interference may occur if the handover doesn't occur earlier.

Soft handover area detection may occur while a mobile device is in any mode or state, for example, the mobile device may be in an idle mode, or a connected mode where it is waiting for data or actively transmitting data. Depending on the mode or state, the mobile device may determine what types of measurements (e.g., inter-frequency measurements) may be made.

One reason for handover may be because the mobile device has reached the end of coverage of a frequency carrier in an extension (e.g., 2.5 GHz) band. The end of extension band coverage may invoke inter-band, inter-frequency or inter-system handover. The trigger criteria may always be the same. As inter-band handovers can possibly be done faster, separate trigger thresholds might be implemented. Some example coverage triggers for example arrangements may include, but are not limited to: handover due to Uplink DCH quality, handover due to UE Tx power, handover due to Downlink DPCH power, handover due to common pilot channel (CPICH) received signal chip power (RSCP), and handover due to CPICH chip energy/total noise (Ec/No). Handover is functional to keep a connection from being dropped while the mobile terminal is moving from one cell to another cell of the network.

Coverage may be another reason for handover. A coverage handover may occur if: (1) the extension band cell has a smaller coverage area (=lower CPICH power or different coverage triggers) than a core band, (2) currently used core band coverage ends (then also extension band), or (3) the UE enters a dead zone.

Intra-frequency measurements may be another reason for soft handover. A soft handover procedure in an extension band may work in principle the same way as in core bands with branch addition, replacement and deletion procedures. SHO procedures may be based on CPICH Ec/IO measurements. Despite stronger attenuation in the extension band, Ec/IO as a ratio may be about the same for both bands. Therefore, in principle the same SHO parameter settings may be used in the extension band. However, if stronger attenuation in an extension band is not compensated for by additional power allocation, the reliability of SHO measurements (Ec/IO) may suffer. Moreover, an extension band cell might have neighbors on extension band frequencies and on core band frequencies at the same time. Then, the UE may have to measure both intra-frequency and inter-band neighbors.

UL interference in the core bands due to delayed soft HO at the extension band coverage edge may occur. An extension band cell may have both extension band neighbors and core band neighbors at the same time. While for the extension band neighbor the normal SHO procedure may be sufficient, for the core band neighbor an early enough inter-band handover may have to be performed. Otherwise, serious UL interference could occur in the core band neighbor cell. SHO areas might be located relatively close to the base station and thus not necessarily relate to high UE Tx (transmit) power (or base transceiver station (BTS) Tx power). Coverage handover triggers may not be sufficient.

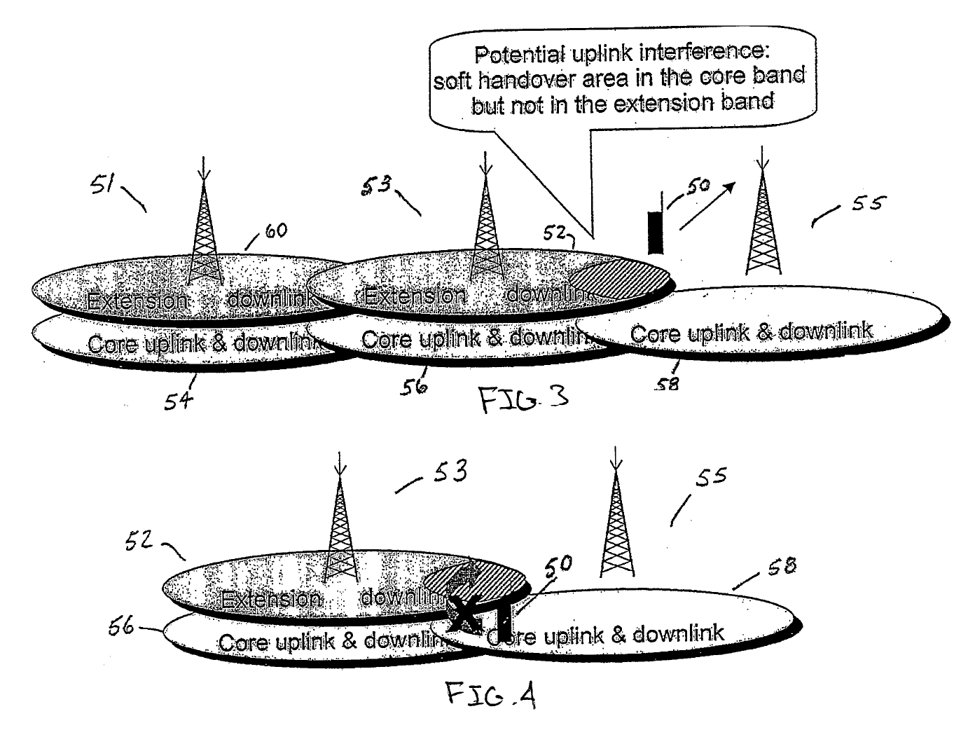

FIG. 3 shows a diagram of a potential interface scenario in an uplink channel according to an example arrangement. Other arrangements are also possible. Three cells or base stations 51, 53, 55 are shown with slight intersection between neighboring (adjacent) coverage areas. The leftmost cell 51 supplies two co-sited bands of frequencies, an extension band of frequencies 60 and a core band of frequencies 54. The middle cell 53 also supplies two co-sited bands of frequencies, an extension band of frequencies 52 and a core band of frequencies 56. The rightmost cell 55 only supplies a core band of frequencies 58.

In this example arrangement, a mobile device (UE) 50 is using a downlink carrier from an extension band of frequencies 52 from the base station 53 closest to the mobile device 50. As the mobile device 50 moves from the left side of base station 53 and approaches cell coverage overlap areas, the mobile device uses UL and DL carriers from neighboring cells (i.e., middle cell 53 and rightmost cell 55). Generally, if the mobile device 50 is using an UL and DL carrier in an extension band (e.g., a band of frequencies starting at approximately 2.5 GHz) cell, once the mobile device 50 moves towards the coverage of a neighboring extension band cell, a soft handover will occur between the DL and UL carriers of the neighbor cells. However, in a situation where there is no neighboring extension band cell as shown here, a soft handover cannot occur since the mobile device 50 must now obtain a DL and UL carrier from a core band (e.g., a band of frequencies starting at approximately 2 GHz) cell. This may cause interference in the UL carrier (not shown) of the neighboring cell.

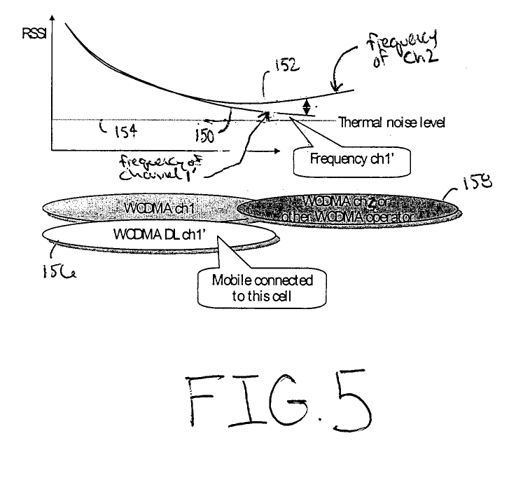

FIG. 4 shows a diagram of another potential interface scenario in an uplink channel according to an example arrangement. Other arrangements are also possible. In this example, the mobile device (UE) 50 is using a downlink carrier from a core band of frequencies 58 from the base station 55. The mobile device 50 may not make a soft handover to the extension band 52 from the base station 53 since the mobile device 50 will be jumping into a potential interference area, causing UL channel interference.

As discussed above, handover may be based on a measured chip energy/total noise (Ec/IO). Ec/IO measurements may be slow because the mobile device may need to use a primary synchronized channel (P-SCH), a secondary synchronized channel (S-SCH) and/or a primary common pilot channel (CPICH) to find the timing of another cell and identify a scrambling code to measure Ec=RSCP. In order to lessen the amount of time and resources needed, embodiments of the present invention may use a received signal strength indicator (RSSI) in order to estimate a chip energy/system noise (Ec/IO) on another carrier when the carriers are co-sited. Co-sited carriers are carriers from the same antenna or same base station or cell as the carrier currently being used. A value of a downlink RSSI may be used during inter-frequency measurements in order to determine situations of handover, for example. The Ec/IO estimation may be used for interference detection, inter-frequency handover, inter-system handover, triggering more accurate measurements, etc.

RSSI measurement may be faster than Ec/IO measurement because RSSI measurement does not require any synchronization to the other carrier. Rather, the RSSI measurement involves the measurement of the total power. Mobile units include the capability of measuring the downlink RSSI at the mobile unit itself. Information related to the measured RSSI may be appropriately forwarded to network elements (i.e., RNCs or BSCs) such as in measurement reports. In accordance with embodiments of the present invention, this RSSI measurement at the mobile unit may be completed in approximately 1-2 time slots, which is 0.625 to 1.25 ms. This clearly improves over disadvantageous arrangements in which the cell identification with compressed mode takes several seconds and requires compressed mode gaps of 7 slots.

More specifically, the Ec/IO (i.e., signal quality) may be estimated based on the RSSI and the Received Signal Chip Power (RSCP). For example, the following equation represents how the Ec/IO may be estimated according to an example embodiment of the present invention:

$$\frac{{E}_{c}}{{I}_{O}} = \frac{RSCP}{RSSI}$$

The RSCP may be estimated by network elements (such as the RNC or BSC) or by the mobile unit. The network elements may estimate the RSCP when the following information is known or is capable of being determined: a) the difference in the frequencies and the frequency attenuation between the carrier and the measured carrier (i.e., the difference between 2.1 GHz and 2.5 GHz is 2-3 dB; and b) the difference in Common Pilot Channel (CPICH) transmission powers. The estimation of the RSCP may utilize synchronization because it filters out chip energy of the pilot power CPICH, neglecting all the other channels transmitting simultaneously on the same carrier.

After estimation of the Ec/IO, various operations may be performed such as interference detection, inter-frequency handover, inter-system handover, triggering more accurate measurement, etc. Information may be transferred to the necessary network elements to perform the desired operations.

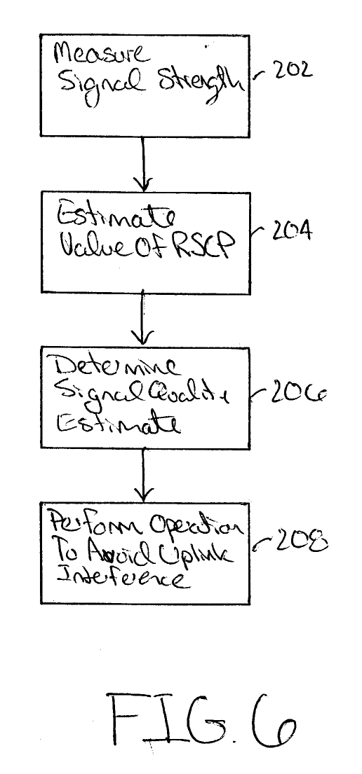

FIG. 5 is a graph showing RSSI versus location. In the graph, the vertical axis represents RSSI whereas the horizontal axis represents the geographical location of the mobile device (i.e., movement of the mobile device). The two curves 150 and 152 represent a measured RSSI at a given location for a frequency of channel 1 of a first cell 156 and a frequency of channel 2 from a second cell 158, respectively. Dashed line 154 represents a thermal noise level at the mobile device. As shown below the graph, the mobile device may be provided within a geographical area of the first cell 156 (in frequency bands shown as ch1 or ch1′) or within a geographical area of the second cell 158 (in frequency band shown as ch2). The graph shows a relationship of RSSI to mobile position. In the upper left of the graph, the RSSI is very high signifying that the mobile device is close to the antenna or base station for that particular operator (or cell). In the lower right of the graph, the RSSI is much lower signifying that the mobile device is farther away from the antenna or base station for that particular operator (or cell). The graph also shows that in the lower right hand corner, the RSSI value is higher along the curve 152 (in the frequency band ch2) than along the curve 150 (in the frequency band ch1′). Embodiments of the present invention may therefore be applicable to perform a handover in order to avoid uplink channel interference.

FIG. 6 is a flowchart showing operations according to an example embodiment of the present invention. Other embodiments, operations and orders of operations are also within the scope of the present invention. More specifically, FIG. 6 shows that a signal strength may be measured in block 202. This may involve the measurement of a downlink RSSI of a co-sited carrier. In block 204, an estimated value of RSCP may be determined. As stated above, the estimated value of RSCP may be performed by a network device (such as an RNC, for example). A signal quality (Ec/IO) estimate may be determined in block 206 based on the measured signal strength and the estimated value of RSCP. In block 208, various operations may be performed in order to avoid uplink interference. This may include, but is not limited to, various types of handovers.

Embodiments of the present invention enable fast detection of possible interference in uplink channels caused by a single UE. The RSSI levels may be measured with a mobile device, and an Ec/IO estimate may be computed by a network element. According to embodiments of the present invention, a much less compressed mode is needed for Ec/IO estimation as compared to Ec/IO measurement. The compressed mode also causes degradation in capacity and coverage and its use should be minimized.

Any reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art. As one example, embodiments of the present invention are also applicable to CDMA systems other than WCDMA.

What is claimed is:

1. A communications method comprising:
measuring a signal strength of a carrier; and
determining a signal quality estimate based on the measured signal strength.

2. The method of claim 1, wherein the signal strength is a received signal strength indicator (RSSI) of a downlink signal for a co-sited carrier.

3. The method of claim 1, wherein the signal quality estimate is an estimate of CPICH Ec/IO.

4. The method of claim 1, further comprising estimating a value of RSCP.

5. The method of claim 4, wherein the estimated value of the RSCP is based on a difference of frequencies and a difference of transmission powers.

6. The method of claim 4, wherein the signal quality estimate is based on the measured signal strength and the estimated value of RSCP.

7. The method of claim 1, further comprising avoiding uplink interference based on the determined signal quality estimate.

8. The method of claim 1, further comprising detecting interference based on the determined signal quality estimate.

9. The method of claim 1, further comprising performing a handover based on the determined signal quality estimate.

10. A method for uplink interference avoidance comprising:
determining a signal quality based on a signal strength of a co-sited carrier; and
performing an operation based on the determined signal quality in order to avoid uplink interference.

11. The method of claim 10, further comprising measuring the signal strength of the co-sited carrier.

12. The method of claim 11, wherein the signal strength is a received signal strength indicator (RSSI) of a downlink signal for the co-sited carrier.

13. The method of claim 10, wherein the signal quality is an estimate of CPICH Ec/IO.

14. The method of claim 10, wherein determining the signal quality includes estimating a value of RSCP.

15. The method of claim 14, wherein the estimated value of RSCP is based on a difference of frequencies and a difference of transmission powers.

16. The method of claim 14, wherein the signal quality is based on the measured signal strength and the estimated value of RSCP.

17. The method of claim 10, wherein performing an operation comprises performing a handover based on the determined signal quality.

18. A communications system comprising:
at least one network device in a communications network; and
a mobile device, the mobile device operatively connected to the communications network,
wherein the mobile device measures a signal strength of a carrier, and the communication system includes a capability to determine a signal quality estimate based on the measured signal strength.

19. The system according to claim 18, wherein the network device comprises a radio network controller to determine the signal quality estimate.

20. The system of claim 18, wherein the signal strength is a received signal strength indicator (RSSI) of a downlink signal for a co-sited carrier.

21. The system of claim 18, wherein the signal quality estimate is an estimate of CPICH Ec/IO.

22. The system of claim 18, wherein the communications system further includes the capability to estimate a value of RSCP.

23. The system of claim 22, wherein the estimated value of RSCP is based on a difference of frequencies and a difference of transmission powers.

24. The system of claim 22, wherein the signal quality estimate is based on the measured signal strength and the estimated value of RSCP.

25. The system of claim 18, wherein the communications system avoids uplink interference based on the determined signal quality estimate.

26. The system of claim 18, wherein the communications system detects interference based on the determined signal quality estimate.

27. The system of claim 18, wherein the communications system performs a handover based on the determined signal quality estimate.
